(19) United States
(12) Patent Application Publication
(10) Pub. No.: US 2003/0066825 A1
(43) Pub. Date: Apr. 10, 2003

(54) Electric stove to cook food

(76) Inventors: Kurt Leutner, Mainz (DE); Oliver Gros, Rheinbollen (DE); Geerd Rupp, Mainz (DE)

Correspondence Address: NILS H. LJUNGMAN, NILS H. LJUNGMAN & ASSOCIATES, P.O. BOX 130, GREENSBURG, PA, 15601-0130, US

(21) Appl. No.: 10/225,079

(22) Filed: Aug. 21, 2002

(30) Foreign Application Priority Data
Aug. 23, 2001 (DE) 101 41 453.6-45

(51) Int. Cl. F24C 15/04; F27D 11/00

(52) U.S. Cl. 219/408; 432/32; 432/250; 126/200

(57) ABSTRACT

There is now provided an electric stove to cook food having electric heating elements to cook food, arrange with the body of the electric stove upon cooking of food with the electric stove and having a structure on the electric stove body to protect the electric stove while cooking with the electric heating elements when the electric heating elements are turned on and when the electric heating elements may be either hot or cold, the exterior of the electric stove from scratches and abrasive wear during use of the electric stove upon cooking with the electric heating elements when the electric heating elements are turned on and when the electric heating elements may be either hot or cold and an inner structure to minimize heat from the interior of the electric stove reaching the exterior of the electric stove during use of the electric heating elements to cook food. This invention is applicable to like appliances. The outer structure has a hardness which is greater than the hardness of inner structure. The outer structure protects the exterior of electric stove from scratches and abrasive wear during use of the electric stove while cooking with the electric heating elements when the electric heating elements are turned off or on and when the electric heating elements may be either hot or cold. The inner structure minimizes heat from the interior of the electric stove reaching the exterior of the electric stove during use of the electric stove while cooking with the electric heating elements and when the electric heating elements are turned off and when the electric heating elements may be either hot or cold and either activated or deactivated.

### BACKGROUND OF THE INVENTION

1. Field of the Invention

This invention relates to an electric stove to cook food having electric heating elements to cook food, arrange with the body of the electric stove upon cooking of food with the electric stove and having a structure on the body of the stove, or like appliance, to protect the exterior of the electric stove from scratches and abrasive wear during use including upon cooking food with the electric heating elements and another structure to minimize heat to the exterior of the electric stove during use upon cooking food with the electric heating elements.

2. Background Information

In general terms, an electric stove to cook food comprises a stove body, with the stove body being configured with a base and the stove body further being configured with an interior chamber confined by walls comprising top and bottom walls, side walls, a front wall, and a rear wall.

An electric stove is an appliance that can be used to cook food at a desired temperature by heat such as heat generated by electrical energy transmitted by heating arrangements.

Electric stoves comprise sufficient insulation to minimize the transmission of heat to the ambient about an electric stove. However, the heat generated by an electric heating arrangement of an electric stove will give rise to dispersal of heat through portions that are not insulated. This is of detriment and needs to be addressed. Such portions of an electric stove that do not carry insulation often lead to excessive heat loss and possibly to unevenness in heat distribution for preparation of food with an electric stove this, in turn, leading to an inadequate degree of doneness of the food being prepared with the stove. There are various ways to attempt to minimize heat losses. One method is the addition of a layer which reflects heat back to the stove. This layer may be disposed at different locations of an electric stove to alleviate heat losses.

There is also a problem with certain parts of a stove being prone to scratches and abrasive wear, for example, caused during cleaning of an electric stove and this affects the overall appearance of an electric stove. Such mars or blemishes lead to a reduced aesthetic value of an electric stove. That is, possibly the utility and the value of an electric stove may be diminished by scratches and abrasive wear on portions of an electric stove.

It is also important for an electric stove to permit viewing of the food that is cooked with an electric stove in a manner that represents the true color of the food that is prepared with an electric stove. Color fidelity is an important feature in that care needs to be taken not to distort colors of food being prepared with an electric stove. That is the true colors of food need to be discernable with sufficient color fidelity. Color neutrality and outstanding transmission properties are maximized when light is transferred without undergoing any adverse change, clearly and without obstruction.

U.S. Pat. No. 5,432,321 issued to Gerl on Jul. 11, 1995 discloses a normal heating device, a partial heating capacity device, a first indicator device associated with the normal heating device, a second indicator device associated with the partial heating capacity device, and a control unit, for an oven. The control unit turns on a full heating capacity of the normal heating device in a preheating phase and turns on the first indicator device to indicate that the normal heating device is on. The control unit turns on the partial heating capacity device in the preheating phase and turns on the second indicator device to indicate the preheating phase. The control unit automatically switches over the normal heating device to a reduced heating capacity in a continued heating phase, when a selected command temperature is reached. The control unit turns off the partial heating capacity device and automatically turns off the second indicator device simultaneously with the switchover to the continued heating phase.

U.S. Pat. No. 5,928,540 issued to Antoine et al. on Jul. 27, 1999 refers to an oven door for closing a cooking chamber of an oven, the door being composed of: a frame on the oven; an inner wall and an outer wall both supported by the frame so that the inner wall is located between the cooking chamber and the outer wall, the inner wall and outer wall being positioned relative to one another to delimit an air space; and ventilation elements for establishing a flow of air between the inner wall and the outer wall in order to maintain the outer wall at a low temperature during a cooking operation, wherein the inner wall is made of glass, and the outer wall is removable from the frame and is made of a plastic material selected to withstand the temperatures to which it will be exposed during any cooking operation.

U.S. Pat. No. 6,427,468 issued to Topper et al. on Aug. 6, 2002 refers to a refrigerator showcase with a plurality of frost shields that are removably positioned about the upper circumferential expanse of the walls of the liner of a refrigerated cabinet. The frost shields are magnetically mountable to the liner to facilitate ease of installation and removal. Each frost shield is a pliable panel fabricated in a layered construction with a relatively thin observe layer of vinyl mounted on nominally thicker back layer of thermoplastic material impregnated with magnetic material. Each frost shield may be provided with a pair of handles inserted in their respective slots formed through the frost shield.

U.S. Pat. No. 6,318,027 issued to Richardson, et al. on Nov. 20, 2001 refers to a refrigerator door for a refrigerated display case which door includes a glass unit having first and second spaced apart glass panels where the first panel has a forward facing surface and the second panel has a rearward facing surface. A spacer element extends between the first and second glass panels. A door rail element includes an external perimeter wall extending from a point adjacent the edge of the first glass panel to a point adjacent the second glass panel. The door rail element also includes a portion which extends within the space between the first and second spaced apart glass panels and a portion which extends externally of the spaced apart glass panels to the perimeter wall. The door rail element further includes a rear wall portion extending inwardly toward the center of the door from the perimeter wall and over a portion of the rearward facing surface of the second glass panel. In one aspect, one or more of the door rail elements may be formed from a composite, for example, resin and glass fibers. The Richardson et al. reference also discloses a method of assembling the door which may include assembling the glass unit and applying a sealant between the first and second glass panels.

Conventional ovens and microwave ovens typically have a view window that allows the user to see the interior of the unit to determine the degree of doneness the food inside. The view windows typically consist of a multilayer glass module with an inside pane and a front pane, and in the case of conventional ovens there is generally an additional middle pane. Refrigerated cases for commercial use also have a view window in the vicinity of the cover, as do the glazed doors of commercial refrigeration and freezer units. Home bottle coolers also have a transparent glazing.

It is known that view windows of this type as well as door and cover glazing, all of which are designated “glazing” in general below, have coatings, the purpose of which is to improve their thermal characteristics, among other things.

For example, the glazing is typically provided with hard films, e.g. with a tin dioxide film applied by pyrolytic spraying. Such hard films are inherently very resistant to scratching, very resistant to high temperatures, and can therefore be used in extreme environments.

Glazings are known in which a soft film is applied, typically by sputtering or immersion, which has the advantages of high thermal insulation (approximately 15 Ohm/unit of surface area), higher light transmission, e.g. 90% compared to 78% for hard films, lower iridescence, better color fidelity, i.e. better color neutrality, although it is less resistant to scratching and to high temperatures.

The application of, respectively, the hard film and the soft film to only one side of the glazing is known. A configuration of this type has the disadvantage of a lower thermal reflection compared to a two-sided coating (approximately 25 Ohm/unit of surface area).

Typically, therefore, the known glazings are provided with a hard film or a soft film. While that of course results in an improved thermal reflection on the one side, it causes a deterioration in the characteristics on the other side. For example, glazings that have hard films on both sides exhibit iridescence effects and frequently have a high degree of cloudiness or opacity, and in general a low transmission of approximately 78%. Moreover, there can be tong imprints when the glazings are manufactured using a vertical production process.

Of course, glazings provided with soft films on both sides have good optics and a very good reflecting power, but the disadvantage is that the soft film can become worn as a result of the constant use of the glazing.

### OBJECT OF THE INVENTION

It is one object of the invention to provide an electric stove to cook food having a structure on the stove body to protect the exterior of the stove from scratches and abrasive wear during use, and another structure to minimize heat from the interior of the electric stove reaching the exterior of the electric stove during use, and like appliances.

It is also an object of the invention to realize the coated glazing described above for heating and cooling appliances so that the coating has good thermal reflection, and so that on the one hand the energy balance of these appliances is improved, and on the other hand the optical properties of the glazing are not adversely affected, and so that all the additional requirements and characteristics during use are satisfied.

### SUMMARY OF THE INVENTION

The invention teaches in one aspect an electric stove to cook food, said electric stove comprising: an electric stove body; said electric stove body being configured with exterior surfaces comprising a base, side walls, a front wall, a top wall, a bottom wall, and a rear wall, said exterior surfaces defining the interior of said electric stove; an electric heating arrangement configured and disposed to provide heat to cook food; control apparatus to control said electric heating arrangement; a planar glass structure disposed at said electric stove body; said planar glass structure comprising a first, outer, surface being disposed at the exterior of said electric stove body, and a second, inner, surface not accessible to a user and being disposed between said first, outer, surface and said interior of said electric stove body; a first, outer, layer disposed substantially fully over said first, outer, surface of said planar glass structure; a second, inner, layer disposed substantially fully over said second, inner, surface of said planar glass structure; said planar glass structure having a hardness; said first, outer, layer having a hardness; said first layer hardness being greater than the planar glass structure hardness; said second, inner, layer having a hardness; said first layer hardness being greater than said second layer hardness; said first, outer, layer being configured to be sufficiently hard to minimize scratches on and abrasive wear to said first, outer, layer and to protect said planar glass structure, at the surface on which said first layer is disposed, from scratches and abrasive wear during use of said electric stove; and said second, inner, layer being configured to minimize throughput of heat through said second, inner, layer and to minimize heat from said interior of said electric stove reaching the exterior of said electric stove during use of said electric stove.

The invention also teaches in one aspect that a soft film is applied on the side of the glazing that is not accessible to the user, and a hard film is applied on the outer side that faces the user.

As a result of the combination taught by one aspect of the invention of the hard film applied to the user side of the glazing and the soft film applied to the side that is not accessible to the user, i.e. the side facing the interior of the appliance, it becomes possible to avoid the disadvantages and to combine the advantages of the hard and soft films with each other, i.e. the glazing coated as taught by one aspect of the present invention has the following characteristics: very high thermal reflection, high transmission, high light transmissivity, low degree of opacity, low iridescence, a good color fidelity, and a good color fidelity index or color fidelity index rating.

The good color fidelity is particularly important in commercial refrigeration units, so that it accurately transmits the identifying colors of the brand-name products displayed inside.

In one configuration of the invention, the soft film is generally formed by a soft metal or metal oxide coating, whereby the coating is preferably an ITO (Indium Tin Oxide) coating.

A coating of this type gives the view window or the glazing a particularly good thermal insulation as well as good optical characteristics.

An effective application of the soft coating is guaranteed if it is applied by sputtering or using a PVD (Physical Vapor Deposition) process.

In a further configuration of the invention, the view window or the glazing can be made particularly scratch-resistant and temperature-resistant if the outer hard coating facing the user is formed by a tin dioxide coating which is preferably sprayed on, although it can also be applied by a CVD (Chemical Vapor Deposition) process.

A coated pane for a view window as claimed by one aspect of the invention is explained in greater detail below.

The above-discussed embodiments of the present invention will be described further hereinbelow. When the word “invention” is used in this specification, the word “invention” includes “inventions”, that is the plural of “invention”. By stating “invention”, the Applicants do not in any way admit that the present application does not include more than one patentably and non-obviously distinct invention, and maintains that this application may include more than one patentably and non-obviously distinct invention. The Applicants hereby assert that the disclosure of this application may include more than one invention, and, in the event that there is more than one invention, that these inventions may be patentable and non-obvious one with respect to the other.

### BRIEF DESCRIPTION OF THE DRAWINGS

The invention is explained in greater detail below with reference to the embodiments which are illustrated in the accompanying drawings.

FIG. 1 is a perspective view of a stove in accordance with one embodiment of the present invention;

FIG. 2 is perspective view of a stove with a microwave oven disposed atop the stove;

FIG. 3 is an elevational view of a stove with a microwave oven disposed in a shelf unit;

FIG. 4 is an elevational view of a stove showing interior components;

FIG. 5 is a perspective view of a stove in accordance with one embodiment of the invention;

FIG. 6 is a perspective schematic view of a refrigerator or freezer in accordance with one embodiment of the invention;

FIG. 7 is a perspective sectional view of a glass pane coated on both sides, with a view of the end surface of the pane;

FIG. 8 is an overhead view in perspective of the glass pane illustrated in FIG. 7;

FIG. 9 is a section through the structure of a multiple glazing, e.g., for the front window of a bottle cooler;

FIG. 10 is a perspective view of a bottle cooler in accordance with one embodiment of the invention;

FIG. 11 is a perspective view of a toaster oven in accordance with one embodiment of the invention; and

FIG. 12 is a perspective view of a combination electric oven and gas stove in accordance with one embodiment of the present invention.

### DESCRIPTION OF THE PREFERRED EMBODIMENT

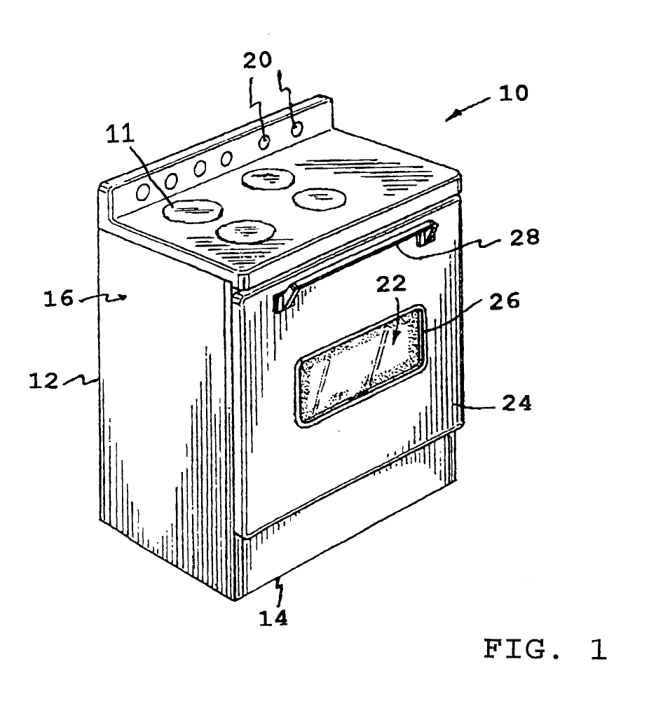

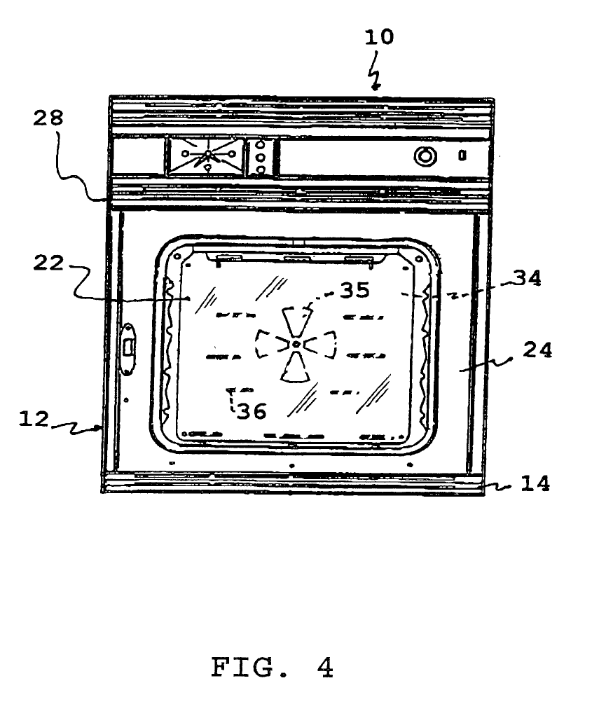

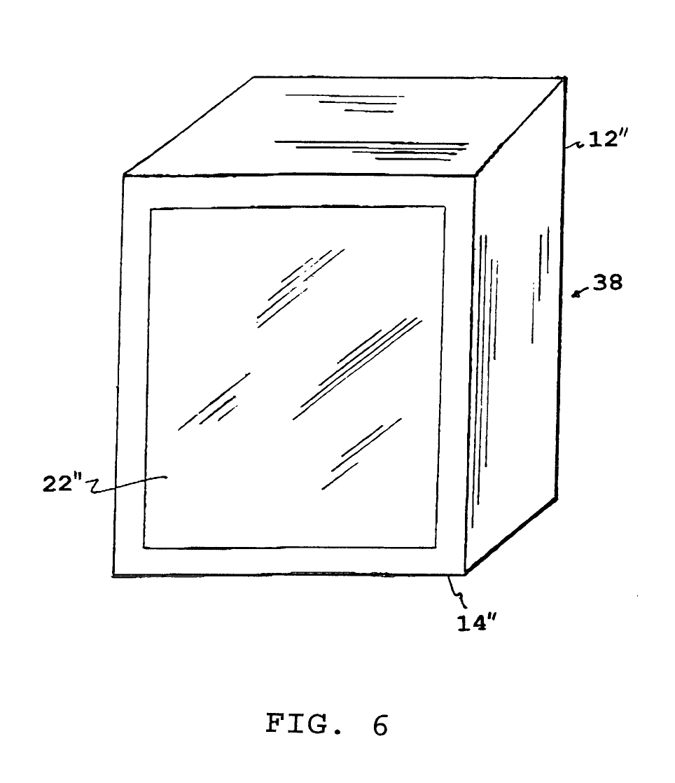

FIG. 1 illustrates an appliance such as, a stove, 10 in accordance with one embodiment of the present invention. Stove 10 may possibly be an electric stove to cook food, the electric stove having a stove body 12 and being configured with exterior surfaces comprising a base 14, and walls generally identified by reference numeral 16, comprising side walls, a front wall, a top wall, a bottom wall, and a rear wall, with the exterior surfaces defining the interior 17 (FIG. 5) of the electric stove 10. The stove 10 has electric heaters 11 and an electric heating arrangement 18 (FIG. 5) configured and disposed to provide heat to cook food, and a control apparatus 20 to control the electric heaters 11 and the heating arrangement 18. A planar glass structure 22 is disposed at the oven door 24 and mounted by an arrangement generally identified by reference numeral 26. The planar structure 22 is further described with reference to FIGS. 7 and 8, herein below. The oven door 24 has a handle 28 to open and close the oven door 24.

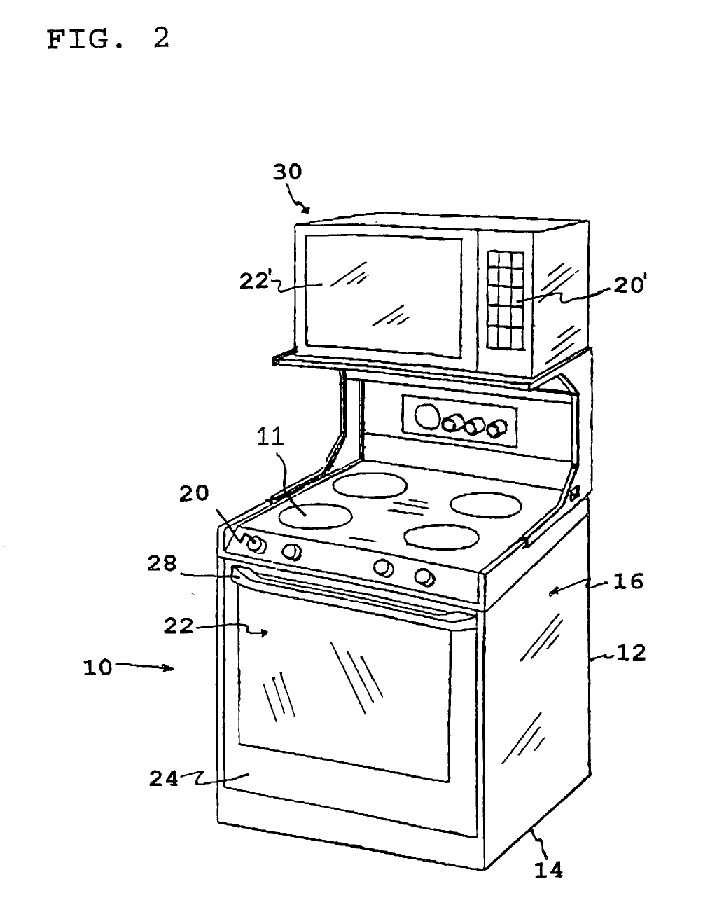

FIG. 2 illustrates a stove 10 with a microwave oven 30, or the like appliance, disposed atop the stove 10. The stove 10 is equipped in the manner described herein above with reference to FIG. 1. Stove 10 comprises a glass structure 22, and the microwave oven 30 comprises a glass structure 22′ of suitable dimensions. These glass structures are further described in reference to FIGS. 7 and 8, herein below.

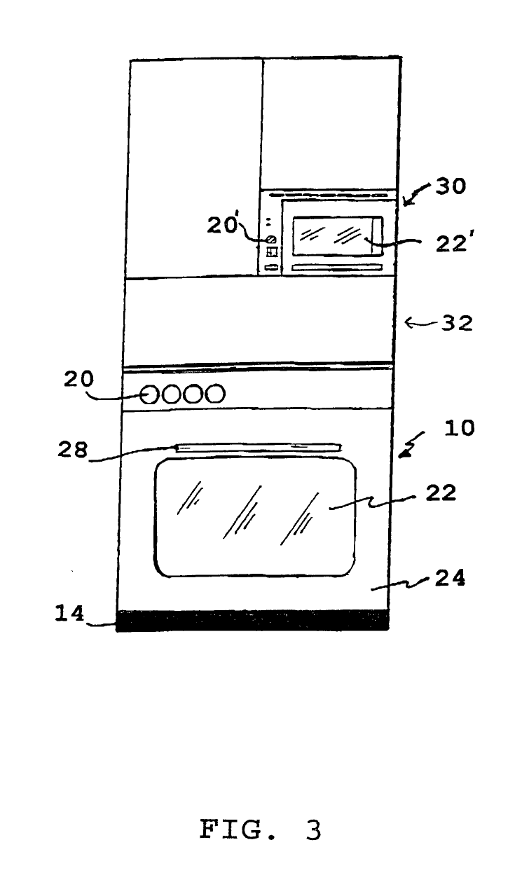

FIG. 3 illustrates a shelf unit 32 with a stove 10 and a microwave oven 30. Stove 10 and microwave oven 30 have corresponding glass structures or windows 22 as will be described in greater detail below with reference to FIGS. 7 and 8.

FIG. 4 illustrates an embodiment of a stove 10 showing interior components, that is a back wall 34 with several apertures 35 in the form of circular sectors through which air can be sucked by a turbine (not illustrated). Other slit-like apertures 36 are formed in the surrounding portions of the back wall 34 to permit the passage of any air forced by the turbine into the oven enclosure. With this arrangement it is thus possible to produce a forced hot air convection within the interior 17. The stove 10 in accordance with FIG. 4 also has a glass structure 22 as will be described in greater detail below with reference to FIGS. 7 and 8.

FIG. 5 illustrates in greater detail the heating arrangement 18 for stove 10 in accordance with one embodiment of the invention. The stove 10 in accordance with FIG. 5 also has a glass structure 22 as will be described in greater detail below with reference to FIGS. 7 and 8.

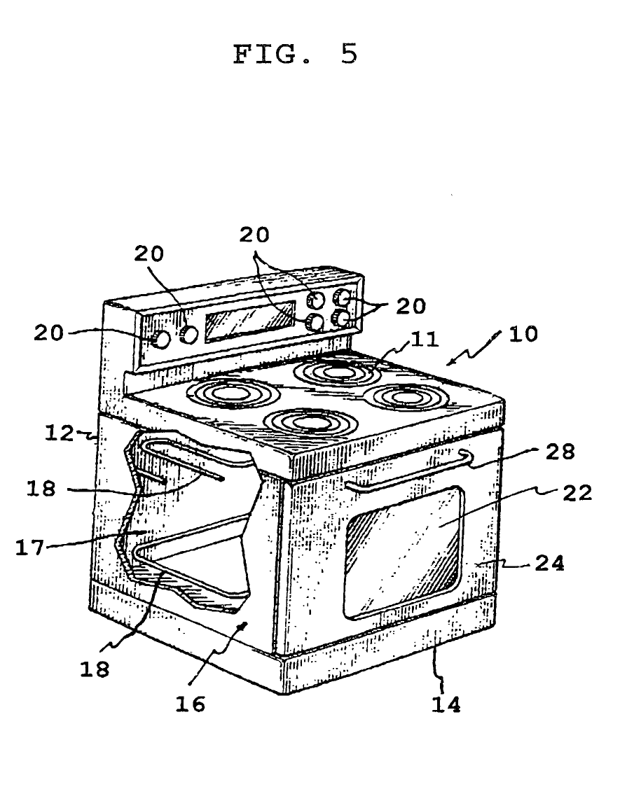

FIG. 6 illustrates schematically a freezer or refrigerator appliance 38. This appliance has a body 12″ and a base 14″ and also has a glass structure 22″ as will be described in greater detail below with reference to FIGS. 7 and 8.

With reference to FIGS. 7 and 8, a soft film 2 is applied to a glass pane 1 for a view window or glazing on heating and cooling appliances, on the side of the glass pane that is not accessible to the user. This coating is preferably a soft metal film or metal oxide film which is applied to the glass panel 1 by sputtering or a PVD process. As materials for this soft film, the following can be considered, among others: (ITO InO:Sn); ZnO:AI; Si+protection layer; Al+protection layer; Au.

On the side facing the user, a hard layer 3 is applied, for example one consisting of doped SnO2, or of materials with comparable properties, by spraying.

The soft film 2 facing the interior of the appliance, as a result of an increase in its reflection action, produces a high level of thermal insulation and gives the view window 2 or the glazing better optical properties, i.e. high transmission, low opacity, low iridescence and good color fidelity. The hard film 3 applied to the side facing the user and exposed to constant “wear”, guarantees a high resistance to scratching and high temperatures.

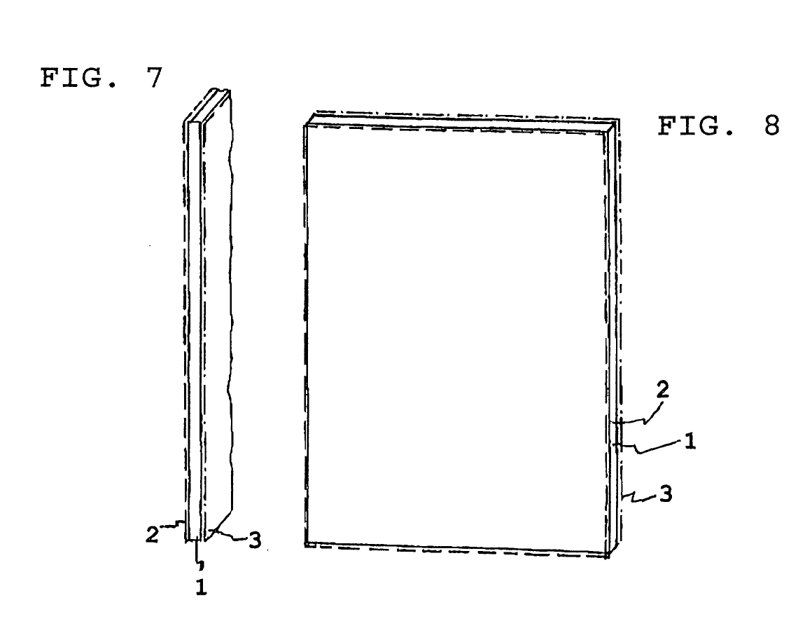

FIG. 9 shows a section through the structure of a multiple-layer glazing of a refrigerated cabinet door. The glass pane 1 facing the interior of the cabinet has the layers that are explained in FIGS. 7 and 8, while the front pane 4 is uncoated. Both glass panes 1 and 4 are held at a specified distance from each other by a spacer 5 which acts as an insulation pane.

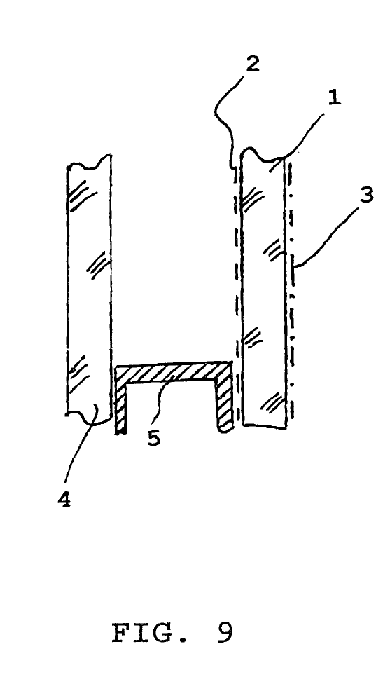

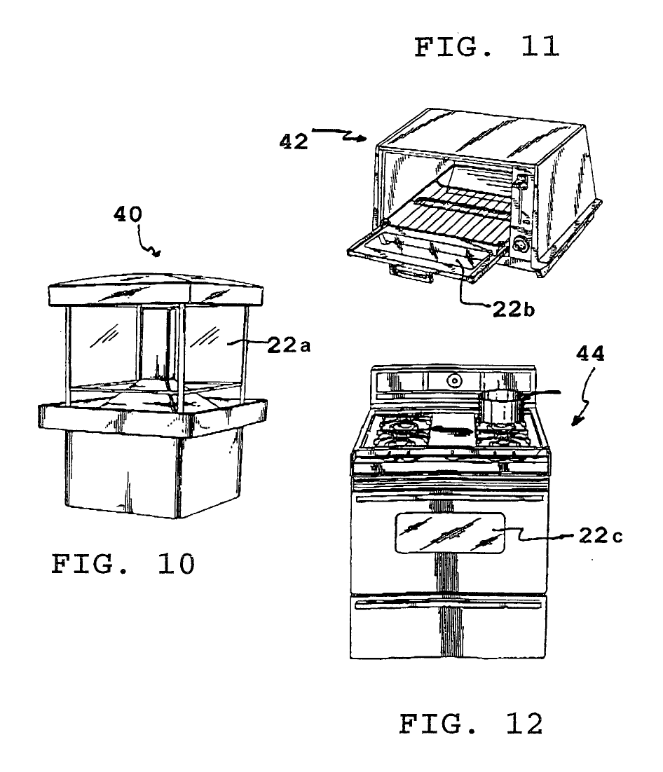

FIG. 10 is a perspective view of a bottle cooler 40 with a glass structure 22a. FIG. 11 is a perspective view of a toaster oven 42 with a glass structure 22b. FIG. 12 is a combination gas stove and electric oven 44 with a glass structure 22c.

In other words, a glass structure 22 comprises at least one glass member 1. The glass member 1 comprises glass material, a first coating, or layer or deposit or structure, 3 and a second coating, or layer or deposit or structure, 2. The first coating 3 is disposed, for example, on the outer surface of the glass material. The second coating 2 is disposed at the interior surface of the glass member 1. The glass member 1 has a hardness, the first coating 3 has a hardness, and the second coating 2 has a hardness, with the first coating hardness being greater than the glass member hardness and the second coating hardness, respectively.

The first coating 3 is configured to be sufficiently hard to minimize scratches on and abrasive wear to the first coating 3 and to protect the glass member 1, at the surface on which the first coating 3 is disposed, from scratches and abrasive wear during use of the appliance 10. The second coating 2 is configured to minimize heat transmission through the second coating 2 and to minimize heat transmission to or from the interior 17 of the appliance 10.

It will be appreciated that the coatings 3 and 2 may be disposed on opposite sides of glass member 1. In one embodiment of the invention, it may be possible that the coatings 3 and 2 are disposed on the same side of the glass member 1, for example, in a pattern.

Glazings in which a soft film is applied, typically by sputtering or immersion, have the advantages of high thermal insulation, approximately 15 Ohm/unit of surface area, higher light transmission, e.g. 90% compared to 78% for hard films, lower iridescence, better color fidelity, i.e. better color neutrality, although a soft film or coating is less resistant to scratching and less resistant to high temperatures. It will be appreciated that the values or ranges of values given herein are by way of example and other values may be determined by experimentation within the scope of the appended claims.

The term Ohm per unit of surface area is a reflection or indication of the thickness of the applicable metal coating, such as metal coating 2 described herein.

The term Ohm per unit of surface area generally is to indicate a unit of surface resistivity of a thin, single material, such as metal coating 2. There is a relationship between thermal reflection and Ohm per unit of surface area and the particular metal coating.

There is a relationship between the thickness of the metal coating and the value of Ohm per unit of surface area for the particular coating. such as a metal coating. By depositing a layer or coating, such as layer or coating 2 described in the foregoing, of a metal with a predetermined thickness on a glass substrate the value of Ohm per unit of surface area will be accordance with the predetermined thickness. When a layer or coating having a greater thickness is utilized, the value of Ohm per unit of surface area is decreased. Conversely when the thickness of the layer is selected to be thin, the value of Ohm per unit of surface area is increased. In some of the materials used, 15 Ohm per unit of surface area provides a coating which will be sufficiently thick to provide sufficient thermal reflection. The value of Ohm per unit of surface area may vary in relation with different coating materials. The layer thickness, with appropriate transparency, can be determined by experimentation in Ohm per unit of surface area, bearing in mind that when the layer thickness is increased, the value of Ohm per unit of surface area decreases and the opacity is increased and thus the transparency is decreased. Conversely, when the layer thickness is reduced the value of Ohm per unit of surface area increases, the opacity decreases and thus the transparency increases. The values or ranges of Ohm per unit of surface area indicated herein, the thermal reflection, the light transmission or transmissivity or transparency, the degree of opacity, the iridescence, and the color fidelity or color index, can be determined by experimentation. In one embodiment, as can be determined by experimentation, the values or ranges of Ohm per unit of surface area may be different from the values or ranges referred to herein. By way of experimentation it can further be determined at what coating or layer thickness sufficient reflection of infrared radiation is achieved, without materially diminishing the transmission of the visible spectrum through the layer or coating, such as layer or coating 2 described herein, such as a light transmission of, for example, 90% for a soft coating or layer 2.

One reference to the German term “Farbwiedergabeindex” that has been translated herein as “color fidelity index”, may be found at website http://home.germany.net/101-81 660/Daten10.htm. The color fidelity index comprises a measure of the color fidelity. A value of 100 corresponds to an absolutely correct color rendition.

One feature of the invention resides broadly in a coated glazing for heating and cooling appliances, characterized by the fact that a soft coating (2) is applied on the side of the view window (1) or glazing that is not accessible to the user, and a hard coating (3) is applied on the outer side facing the user.

Another feature of the invention resides broadly in the glazing characterized by the fact that the soft coating (2) is formed by a soft metal or metal oxide coating.

Yet another feature of the invention resides broadly in the glazing characterized by the fact that the material of the metal or metal oxide coating is formed from a metal of the group Ag, Al, Au etc.

Still another feature of the invention resides broadly in the glazing characterized by the fact that the soft coating (2) is applied by sputtering or applied using a PVD process.

A further feature of the invention resides broadly in the glazing characterized by the fact that the hard coating (3) is formed by a dosed SnO₂ layer.

Another feature of the invention resides broadly in the glazing characterized by the fact that the hard layer (3) is sprayed on or applied using a CVD process.

Thus, in one aspect, the invention relates in one aspect in particular to a coated glazing for heating and cooling appliances used as a view window for said appliances. The coatings of these view windows or glazings are intended to improve their thermal and mechanical properties. To thereby eliminate any adverse effect on the optical properties, the invention teaches in one aspect that a soft film (2) is applied to the side of the view window (1) or glazing facing the interior of the appliance, and a hard film (3) is applied to the outer side facing the user.

In one aspect, the invention relates to an electric stove to cook food having a structure on the electric stove body to protect the exterior of the electric stove from scratches and abrasive wear during use of the electric stove and an inner structure to minimize heat from the interior of the electric stove reaching the exterior of the electric stove during use. This invention is applicable to like appliances. The outer structure has a hardness which is greater than the hardness of inner structure. The outer structure protects the exterior of electric stove from scratches and abrasive wear during use of the electric stove. The inner structure minimizes heat from the interior of the electric stove reaching the exterior of the electric stove during use of the electric stove.

The features disclosed in the various publications, disclosed or incorporated by reference herein, may be used in the embodiments of the present invention, as well as, equivalents thereof.

FIG. 1 is a copy of FIG. 2 from U.S. Pat. No. 6,024,084 issued to Gerhardinger on Feb. 15, 2000 and entitled “Double sided heat barrier glass with clear CVD coating and method of making the same,” from which figure copy all of the reference numerals present in the original figure, as it appears in U.S. Pat. No. 6,024,084, have been removed. U.S. Pat. No. 6,024,084 is hereby incorporated by reference as if set forth in its entirety. The reference numerals that have been removed from FIG. 2 for this U.S. patent, essentially reproduced herein as FIG. 1, indicate arrangements that are well known in the prior art.

The corresponding foreign patent application, namely, Federal Republic of Germany Patent Application No. 101 41 453.6-45, filed on Aug. 23, 2001, having inventors Kurt LEUTNER, Oliver GROS, and Geerd RUPP, and DE-OS 101 41 453 and DE-PS 101 41 453, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein, are hereby incorporated by reference as if set forth in their entirety herein.

FIG. 2 is a copy of FIG. 1 from U.S. Pat. No. 4,414,959 issued to Fair et al. on Nov. 15, 1983 and entitled, “Shelf for a range,” from which figure copy all of the reference numerals present in the original figure, as it appears in U.S. Pat. No. 4,414,959, have been removed. U.S. Pat. No. 4,414,959 is hereby incorporated by reference as if set forth in its entirety. The reference numerals that have been removed from FIG. 1 for this U.S. patent, essentially reproduced herein as FIG. 2, indicate arrangements that are well known in the prior art.

All of the references and documents, cited in any of the documents cited herein, and the references they are in turn cited in are hereby incorporated by reference as if set forth in their entirety herein. All of the documents cited herein, referred to in the immediately preceding sentence, include all of the patents, patent applications and publications cited anywhere in the present application. All of the references included herein as aforesaid include the corresponding equivalents published by the United States Patent and Trademark Office and elsewhere.

FIG. 4 is a copy of FIG. 1 from U.S. Pat. No. 4,413,171 issued to Klammers on Nov. 1, 1983 and entitled, “Electric cooking oven for domestic use,” from which figure copy all of the reference numerals present in the original figure, as it appears in U.S. Pat. No. 4,413,171, have been removed. U.S. Pat. No. 4,413,171 is hereby incorporated by reference as if set forth in its entirety. The reference numerals that have been removed from FIG. 1 for this U.S. patent, essentially reproduced herein as FIG. 4, indicate arrangements that are well known in the prior art.

Another foreign patent publication application, namely, Federal Republic of Germany Patent Application No. DE 100 17 701.8-45, filed on Apr. 8, 2000, [NHL-FMW-01 US (SCT)] having inventors Dr. Friedrich SIEBERS, Dr. Peter NAβ, Dr. Gerhard LAUTENSCHLAGER, and Dr. Otmar BECKER, entitled, “Gefloatetes Flachglas,” and DE-OS 100 17 701.8-45 and DE-PS 100 17 701.8-45, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

FIG. 5 is a copy of FIG. 1 from U.S. Pat. No. 4,775,777 issued to Sinn on Oct. 4, 1988 and entitled, “Open-loop self-cleaning oven temperature control,” from which figure copy all of the reference numerals present in the original figure, as it appears in U.S. Pat. No. 4,775,777, have been removed. U.S. Pat. No. 4,775,777 is hereby incorporated by reference as if set forth in its entirety. The reference numerals that have been removed from FIG. 1 for this U.S. patent, essentially reproduced herein as FIG. 5, indicate arrangements that are well known in the prior art.

The details in the patents, patent applications and publications may be considered to be incorporable, at Applicants' option, into the claims during prosecution as further limitations in the claims to patentably distinguish any amended claims from any applied prior art.

FIG. 6 is a copy of FIG. 1 from U.S. Pat. No. 6,268,594 issued to Leutner et al. on Jul. 31, 2001 and entitled, “Appliance such as a refrigerator or freezer with a transparent viewing door and a method of manufacture of a refrigerator or freezer with a transparent viewing door. U.S. Pat. No. 6,268,594 relates to a multipane insulating glass, for appliances having an inner-chamber temperature which is lower than the ambient temperature, in particular for viewing doors of refrigerators and freezers, that comprises at least two panes which are of approximately equal size and are arranged at a distance from one another. The distance is maintained by a spacer which runs continuously around the vicinity of the edge. The reference numerals present in FIG. 1 of U.S. Pat. No. 6,268,594 have been removed and modified herein to suit the context of this specification. U.S. Pat. No. 6,268,594 is hereby incorporated by reference as if set forth in its entirety. The reference numerals that have been removed from FIG. 1 for this U.S. patent, essentially reproduced herein as FIG. 6, indicate arrangements that are well known in the prior art.

The following U.S. patent application is to be incorporated by reference as follows: U.S. patent application Ser. No. 09/828,288, filed on Apr. 6, 2001, entitled, “A cooking arrangement for cooking food such as a stove, a cooktop, and other cooking appliances, with an easy-to-clean surface,” having attorney docket No. NHL-FMW-01 US (SCT), having inventors Dr. Sabine MELSON, Dr. K. SCHAUPERT, and Dr. Peter NAβ, and is hereby incorporated by reference as if set forth in its entirety herein.

The appended drawings in their entirety, including all dimensions, proportions and/or shapes in at least one embodiment of the invention, are accurate and to scale and are hereby included by reference into this specification.

Another foreign patent publication application, namely, Federal Republic of Germany Patent Application No. DE 100 32 733.8-16, filed on Jul. 5, 2000, [NHL-FMW-07 US (SCT)] having inventors Kurt LEUTNER and Oliver GROS, entitled, “Sichtfenster fur Haushaltsgerate,” and DE-OS 100 32 733 and DE-PS 100 32 733, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

The following U.S. patent application is to be incorporated by reference as follows: U.S. patent application Ser. No. 09/898,918, filed on Jul. 3, 2001, entitled, “Stove for cooking food with a viewing window, and a viewing window for household appliances, such as cooking stoves or ovens,” having attorney docket No. NHL-FMW-07 US (SCT), having inventors Kurt LEUTNER and Oliver GROS, and is hereby incorporated by reference as if set forth in its entirety herein.

Another foreign patent publication application, namely, Federal Republic of Germany Patent Application No. DE 200 16 145.8, filed on Sep. 18, 2000, [NHL-FMW-08 US (SCT)] having inventor Torsten GABELMANN, entitled, “Kochfeld mit mindestens einem atmospharischen Gasbrenner,” and DE-OS 200 16 145 and DE-PS 200 16 145, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

The following U.S. patent application is to be incorporated by reference as follows: U.S. patent application Ser. No. 09/952,314, filed on Sep. 14, 2001, entitled, “A gas stove for cooking food with at least one gas burner and a gas cooktop for cooking food with at least one gas burner,” having attorney docket No. NHL-FMW-08 US (SCT), having inventor Torsten GABELMANN, and is hereby incorporated by reference as if set forth in its entirety herein.

All, or substantially all, of the components and methods of the various embodiments may be used with at least one embodiment or all of the embodiments, if more than one embodiment is described herein.

Another foreign patent publication application, namely, Federal Republic of Germany Patent Application No. DE 100 57 604.4, filed on Nov. 21, 2001, [NHL-FMW-09 US (SCT)] having inventors Oliver GROS and Dr. Peter NAβ, entitled, “Sichtfenster fur Backofen,” and DE-OS 100 57 604 and DE-PS 100 57 604, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

The following U.S. patent application is to be incorporated by reference as follows: U.S. patent application Ser. No. 09/990,590, filed on Jul. 3, 2001, entitled, “Stove for cooking food with a viewing window, and a viewing window for household appliances, such as cooking stoves or ovens,” having attorney docket No. NHL-FMW-09 US (SCT), having inventors Oliver GROS and Dr. Peter NAβ, and is hereby incorporated by reference as if set forth in its entirety herein.

All of the patents, patent applications and publications recited herein, and in the Declaration attached hereto, are hereby incorporated by reference as if set forth in their entirety herein.

U.S. Pat. No. 6,148,812, having attorney docket No. NHLSCT-01-C-US, having inventors Taplan et al., issued on Nov. 21, 2000, entitled, “Cooking unit, such as a stove, for cooking food”; U.S. Pat. No. 6,002,112, having attorney docket No. NHL-SCT-03 US, having inventors NAβ et al., issued on Dec. 14, 1999, entitled, “Cooking appliance, such as a stove with a glass-ceramic hob or cooktop with a rapid cooking ring or hotplate”; U.S. Pat. No. 6,111,229, having attorney docket No. SCT-04 US, having inventor Schultheis, issued on Aug. 29, 2000, entitled, “Cooking appliance such as a stove with an arrangement of a ceramic heating element as cooking zone in a cutout of a cooking surface”; U.S. Pat. No. 6,050,176, having attorney docket No. SCT-05 US, having inventors Schultheis et al., issued on Apr. 18, 2000, entitled, “Arrangement of a hotplate in a cooktop; and U.S. Pat. No. 6,236,024, having attorney docket No. NHL-SCT-09 US, having inventors Gotz et al., issued on May 22, 2001, entitled, “Cooktop or stove having an arrangement of a one-piece molded part made of glass-ceramic, glass or ceramic in the cooking surface area of the cooking unit in a cutout of a sill plate;” U.S. patent application Ser. No. 09/522,460, entitled, “Cooking unit, such as a stove, for cooking food,” having attorney docket No. NHL-SCT-10 US, having inventors DipI.-Ing. Michael MUSKALLA, Keramik-Ing. Werner HOTTUM, and DipI.-Ing. Bernd SCHULTHEIS, filed on Mar. 9, 2000; and U.S. patent application Ser. No. 09/898,892, entitled, “Cooking stove having a smooth-top glass ceramic cooktop, and a smooth-top glass ceramic cooktop with a glass ceramic cooktop cooking surface, method for production of stoves with smooth-top glass ceramic cooktops and smooth-top glass ceramic cooktops,” having attorney docket No. NHLSCT-26 US, having inventors Ina MITRA, Friedrich SIEBERS, Otmar BECKER, Andreas SCHMINKE, Bernd RUDINGER, Christian ROOS, Evelin WEISS, Roland DUDEK, Erich RODEK, and Friedrich-Georg SCHRODER, filed on Jul. 3, 2001, are hereby incorporated by reference as if set forth in their entirety herein.

U.S. patent application Ser. No. 09/758,953, entitled, “Stove or grill for cooking, and stove or grill for cooking having a glass-ceramic cooktop or hob, and a glass-ceramic plate cooktop or hob for use in a stove or grill,” having attorney docket No. NHL-GAI-01 (SCT) US, having inventors loannis KOSMAS, Dietmar WENNEMANN, and Joachim GRUTZKE, filed on Jan. 11, 2001; U.S. patent application Ser. No. 09/866,989, entitled, “Method of treating a smooth-top kitchen ceramic or glass ceramic cooktop cooking surface of a smooth-top kitchen ceramic or glass ceramic cooktop or a stove having a ceramic or glass ceramic cooktop cooking surface, and a device therefor,” having attorney docket No. NHL-GAI-02 (SCT) US, having inventors Bernd SCHULTHEIS, AND Monica D E WITZMANN, filed on May 29, 2001; U.S. patent application Ser. No. 09/931,586, entitled, “Stove for cooking food and like appliances with a door having a window and a temperature indicating device thereon,” having attorney docket No. NHL-GAI-03 (SCT) US, having inventors Kurt LEUTNER, Oliver GROS, Joachim GRUTZKE, Bernhard GOTZ, and Walter GRAMLICH, filed on Aug. 16, 2001; and U.S. patent application Ser. No. 10/059,052, entitled, “A kitchen gas cooking stove with a glass-ceramic, glass, or ceramic top, a gas cooktop with a glass-ceramic, glass, or ceramic top, and a glass-ceramic, glass, or ceramic top of a cooking stove or cooktop with a venting structure thereon,” having attorney docket No. NHLGAI-04 (SCT), having inventors Martin TAPLAN and Theodor Allen WEGERT, filed on Jan. 28, 2002, are hereby incorporated by reference as if set forth in their entirety herein.

The following U.S. patents being of interest in connection with cooktops are to be incorporated by reference herein as follows: U.S. Pat. No. 6,024,084, having inventor Gerhardinger, issued on Feb. 15, 2000, entitled, “Double sided heat barrier glass with clear CVD coating and method of making the same”; U.S. Pat. No. 5,958,272, having inventors Taplan et al., issued on Sep. 28, 1999, entitled, “Cooktop with a glass or glass ceramic cooking surface”; and U.S. Pat. No. 4,413,171, having inventor Klammers, issued on Nov. 1, 1983, entitled, “Electric cooking oven for domestic use,” are hereby incorporated by reference as if set forth in their entirety herein.

Some examples of stoves and ranges which may possibly be utilized or possibly adapted for use in at least one possible embodiment of the present invention may be found in the following U.S. Pat. No. 5,083,010, having inventors Henry et al., issued on Jan. 21, 1992; No. 4,601,279, having inventor Guerin, issued on Jul. 22, 1986; No. 4,493,976, having inventor Wilson, issued on Jan. 15, 1985; No. 4,292,501, having inventor Maitenaz, issued on Sep. 29, 1981; No. 5,213,091, issued on May 25, 1993; No. D336,210, issued on Jun. 8, 1993; No. 5,280,152, issued on Jan. 18, 1994; No. 5,290,997, issued on Mar. 1, 1994; No. 5,400,765, issued on Mar. 28, 1995; No. D359,345, issued on Jun. 13, 1995; No. D361,015, issued on Aug. 8, 1995; and No. 5,464,005, issued on Nov. 7, 1995. All of the patents cited herein are hereby expressly incorporated by reference as if fully set forth in their entirety herein.

Some examples of ceramic plates or hot plates which may be possibly utilized or possibly adapted for use in at least one possible embodiment of the present invention may be found in the following U.S. Pat. No. 3,596,650, issued on Aug. 3, 1971; No. 3,870,861, issued on Mar. 11, 1975; No. 4,414,465, issued on Nov. 8, 1983; No. 4,634,841, issued on Jan. 6, 1987; and No. 5,397,873, issued on Mar. 14, 1995. All of the patents cited herein are hereby expressly incorporated by reference as if fully set forth in their entirety herein.

Some examples of ceramic materials which may possibly be utilized or possibly adapted for use in at least one possible embodiment of the present invention may be found in the following U.S. Pat. No. 5,385,873, issued on Jan. 31, 1995; No. 5,407,740, issued on Apr. 18, 1995; No. 5,420,399, issued on May 30, 1995; No. 5,422,319, issued on Jun. 6, 1995; No. 5,449,649, issued on Sep. 12, 1995; No. 5,476,684, issued on Dec. 19, 1995; and No. 5,691,261, issued on Nov. 25, 1997. All of the patents cited herein are hereby expressly incorporated by reference as if fully set forth in their entirety herein.

Some examples of flat glass production which may possibly be incorporated in a possible embodiment or example of the present invention may be found in U.S. Pat. No. 3,218,143 issued to De Lajarte on Nov. 16, 1965 and entitled “Process for the manufacture of flat glass”; U.S. Pat. No. 3,930,826 issued to Schornhorst on Jan. 6, 1976 and entitled “Conditioning flat glass for removal from supporting liquid following forming”; U.S. Pat. No. 3,938,979 issued to Plumat on Feb. 147, 1976 and entitled “Method and apparatus for vertically drawing a glass ribbon”; U.S. Pat. No. 4,801,321 issued to Pita et al. on Jan. 31, 1989 and entitled “Method for the manufacturing of glass sheets”; U.S. Pat. No. 4,214,886 issued to Shay et al. on Jul. 29, 1980 and entitled “Forming laminated sheet glass”; U.S. Pat. No. 4,209,315 issued to Spurling on Jun. 24, 1980 and entitled “Glass forming apparatus”; U.S. Pat. No. 4,929,266 issued to Cozac et al. on May 29, 1990 and entitled “Method of manufacturing glass”; and U.S. Pat. No. 5,078,777 issued to Cozac et al. on Jan. 7, 1992 and entitled “Glass-melting furnace”. All of the patents cited herein are hereby expressly incorporated by reference as if fully set forth in their entirety herein.

Some examples of keatite and/or high quartz mixed crystal formation, features of which may possibly be incorporated in a possible embodiment of the present invention may be found in the following U.S. Pat. No. 3,938,978 issued to Hummel on Feb. 17, 1976 and entitled, “Method of making crystallized glass,” No. 3,970,463 issued to Planchock et al. on Jul. 20, 1976 and entitled, “Glasses and glass-ceramics and products made therefrom,” No. 4,011,091 issued to McCollister on Mar. 8, 1977 and entitled, “Ceramic materials containing keatite,” No. 4,100,001 issued to Franklin on Jul. 11, 1978 and entitled, “Thermally crystallizable glasses and glass-ceramics made therefrom,” No. 4,391,914 issued to Beall et al. on Jul. 5, 1983 and entitled, “Strengthened glass-ceramic articles and method,” No. 4,861,734 issued to MacDowell on Aug. 29, 1989 and entitled, “Alkaline earth aluminoborate glass-ceramics,” No. 5,212,122 issued to Pannhorst et al. on May 18, 1993 and entitled, “Transparent colored glass ceramic with good thermal stability and variable transmission in the IR region,” and No. 6,043,171 issued to Siebers et al. on Mar. 28, 2000 and entitled, “Lead-free and cadmium-free glass compositions for glazing, enamelling and decorating glass of glass-ceramics.” All of the patents cited herein are hereby expressly incorporated by reference as if fully set forth in their entirety herein.

Some examples of ceramicizing or ceramising glass-ceramic or glass, features of which may possibly be incorporated in a possible embodiment of the present invention may be found in U.S. Pat. No. 4,824,463 issued to Neuhoff et al. on Apr. 25, 1989 and entitled “Process for ceramising glass-ceramic sheets”; and U.S. Pat. No. 4,851,022 issued to Gunthner on Jul. 25, 1989 and entitled “Method and oven for ceramising glass plates.” All of the patents cited herein are hereby expressly incorporated by reference as if fully set forth in their entirety herein.

Some examples of crystallizable glass and glass-ceramics made therefrom, features of which may possibly be incorporated in a possible embodiment of the present invention may be found in U.S. Pat. No. 3,970,463 issued to Planchock et al. on Jul. 20, 1976 and entitled “Glasses and glass-ceramics and products made therefrom”; U.S. Pat. No. 4,011,091 issued to McCollister on Mar. 8, 1977 and entitled “Ceramic materials containing keatite”; U.S. Pat. No. 4,100,001 issued to Franklin on Jul. 11, 1978 and entitled “Thermally crystallizable glasses and glass-ceramics made therefrom”; U.S. Pat. No. 4,126,476 issued to Grossman on Nov. 21, 1978 and entitled “Aluminous quartz ceramics and method”; U.S. Pat. No. 4,391,914 issued to Beall et al. on Jul. 5, 1983 and entitled “Strengthened glass-ceramic article and method”; U.S. Pat. No. 6,197,710 issued to Ohara et al. on Mar. 6, 2001 and entitled “Luminous glass ceramics”; and U.S. Pat. No. 6,204,211 issued to Ohara et al. on Mar. 20, 2001 and entitled “Luminous glass ceramics”. All of the patents cited herein are hereby expressly incorporated by reference as if fully set forth in their entirety herein.

Some examples of metal coatings for glass, features of which may possibly be used or adapted for use in at least one embodiment of the present invention may be found in the following U.S. Pat. No. 4,975,301 issued to Andrews et al. on Dec. 4, 1990; No. 5,093,153 issued to Brochot et al. on Mar. 3, 1992; No. 5,112,440 issued to Banks et al. on May 12, 1992; No. 5,256,485 issued to Terneu et al. on Oct. 26, 1993; No. 5,306,547 issued to Hood et al. on Apr. 26, 1994; No. 5,374,451 issued to Servais et al. on Dec. 20, 1994; No. 5,632,942 issued to Yeh et al. on May 27, 1997; No. 5,718,980 issued to Koch et al. on Feb. 17, 1998; No. 5,772,716 issued to Krohm et al. on Jun. 30, 1998; No. 5,858,456 issued to Nordlander on Jan. 12, 1999; No. 5,882,435 issued to Holdermann on Mar. 16, 1999; No. 5,925,415 issued to Fry et al. on Jul. 20, 1999; No. 5,953,478 issued to Sanghera et al. on Sep. 14, 1999; No. 6,093,452 issued to Ishii et al. on Jul. 25, 2000; No. 6,207,221 issued to Schulz-Harder on Mar. 27, 2001; No. 6,231,925 issued to Davlin on May 15, 2001; No. 6,398,925 issued to Arbab et al. on Jun. 4, 2002; and No. 6,426,126 issued to Conover et al. on Jul. 30, 2002. All of the patents cited herein are hereby expressly incorporated by reference as if fully set forth in their entirety herein.

Some examples of non-glare coated glass, features of which may possibly be used or adapted for use in at least one embodiment of the present invention may be found in the following U.S. Pat. No. 4,578,100 issued to Breininger on Mar. 25, 1986; No. 4,636,439, issued to Breininger on Jan. 13, 1987; No. 4,944,986 issued to Zuel on Jul. 31, 1990; No. 5,196,088 issued to Soda on Mar. 23, 1993; No. 5,318,724 issued to Hasegawa et al. on Jun. 7, 1994; No. 5,334,409 issued to Sohn et al. on Aug. 2, 1994; No. 5,490,161 issued to Tanuma on Feb. 6, 1996; and No. 6,238,781 issued to Anderson et al. on May 29, 2001. All of the patents cited herein are hereby expressly incorporated by reference as if fully set forth in their entirety herein.

Some examples of tempered glass, features of which may possibly be used or adapted for use in at least one embodiment of the present invention may be found in the following U.S. Pat. No. 3,938,980 issued to French on Feb. 17, 1976; No. 4,620,864 issued to McMaster on Nov. 4, 1986; No. 4,681,616 issued to McMaster on Jul. 21, 1987; No. 4,735,646 issued to Aratani et al. on Apr. 5, 1988; No. 6,079,227 issued to Yoshizawa et al. on Jun. 27, 2000; and No. 6,257,228 issued to Braccini on Jul. 10, 2001. All of the patents cited herein are hereby expressly incorporated by reference as if fully set forth in their entirety herein.

Some examples of coating by vapor deposition, features of which may possibly be used or adapted for use in at least one embodiment of the present invention may be found in the following U.S. Pat. No. 4,835,040 issued to Callies et al. on May 30, 1989; No. 4,900,110 issued to Sleighter on Feb. 13, 1990; No. 5,217,753 issued to Goodman et al. on Jun. 8, 1993; No. 5,401,305 issued to Russo et al. on Mar. 28, 1995; No. 5,798,142 issued to Soubeyrand on Aug. 25, 1998; No. 6,235,343 issued to Joret et al. on May 22, 2001; and No. 6,238,738 issued to McCurdy on May 29, 2001. All of the patents cited herein are hereby expressly incorporated by reference as if fully set forth in their entirety herein.

Some examples of coating by sputtering, features of which may possibly be used or adapted for use in at least one embodiment of the present invention may be found in the following U.S. Pat. No. 4,274,936 issued to Love on Jun. 23, 1981; No. 4,462,883 issued to Hart on Jul. 31, 1984; No. 5,073,451 issued to lida et al. on Dec. 17, 1991; No. 5,112,675 issued to Wuest et al. on May 12, 1992; No. 6,039,850 issued to Schulz on Mar. 20, 2000; and No. 6,190,776 issued to Demiryont on Feb. 20, 2001. All of the patents cited herein are hereby expressly incorporated by reference as if fully set forth in their entirety herein.

Some examples of coating by dipping, features of which may possibly be used or adapted for use in at least one embodiment of the present invention may be found in the following U.S. Pat. No. 4,081,254 issued to Matsumoto et al. on Mar. 28, 1978; No. 4,842,630 issued to Braithwaith et al. on Jun. 27, 1989; No. 5,492,613 issued to Zhang et al. on Feb. 20, 1996; No. 5,572,086 issued to Tong et al. on Nov. 5, 1996; No. 5,858,052 issued to Kopylov on Jan. 12, 1999; and No. 6,050,870 issued to Suginoya et al. on Apr. 18, 2000. All of the patents cited herein are hereby expressly incorporated by reference as if fully set forth in their entirety herein.

Some examples of coating by spraying, features of which may possibly be used or adapted for use in at least one embodiment of the present invention may be found in the following U.S. Pat. No. 4,917,717 issued to Thomas et al. on Apr. 17, 1990; No. 5,124,211 issued to Kawahara et al. on Jun. 23, 1992; No. 6,099,905 issued to Rouquette et al. on Aug. 8, 2000; No. 6,120,661 issued to Hirano et al. on Sep. 19, 2000; No. 6,177,186 issued to Skoog et al. on Jan. 23, 2001; and No. 6,254,938 issued to Pranevicius et al. On Jul. 3, 2001. All of the patents cited herein are hereby expressly incorporated by reference as if fully set forth in their entirety herein.

Some examples of coating by electroless metallizing, features of which may possibly be used or adapted for use in at least one embodiment of the present invention may be found in the following U.S. Pat. No. 4,448,811 issued to Doty et al. on May 15, 1984; No. 4,913,768 issued to Wolf et al. on Apr. 3, 1990; No. 4,997,686 issued to Feldstein et al on Mar. 5, 1991; No. 5,035,924 Massa et al. on Jul. 30, 1991; No. 5,304,403 Schlesinger et al. on Apr. 19, 1994; and No. 6,221,440 issued to Meyer et al. on Apr. 24, 2001. All of the patents cited herein are hereby expressly incorporated by reference as if fully set forth in their entirety herein.

Some further examples of glass ceramics, features of which may possibly be used or adapted for use in at least one embodiment of the present invention may be found in the following U.S. Pat. No. 5,562,957 issued to Hilden on Oct. 8, 1996; No. 5,660,934 issued to Longo on Aug. 26, 1997; No. 5,718,970 issued to Longo on Feb. 17, 1998; No. 5,739,180 issued to Taylor-Smith on Apr. 14, 1998; No. 5,844,206 issued to Steiner et al. on Dec. 1, 1998; No. 5,885,663 issued to Longo on Mar. 23, 1999; No. 5,990,457 issued to Steiner et al. on Nov. 23, 1999; No. 6,120,282 issued to Vilato et al. on Sep. 19, 2000; No. 6,124,576 issued to Zapf et al. on Sep. 26, 2000; No. 6,170,479 issued to Taplan on Jan. 9, 2001; and No. 6,209,534 issued to Taplan on Apr. 3, 2001. All of the patents cited herein are hereby expressly incorporated by reference as if fully set forth in their entirety herein.

Some examples of oxide coatings, features of which may possibly be used or adapted for use in at least one embodiment of the present invention may be found in the following U.S. Pat. No. 5,256,485 issued to Terneu et al. on Oct. 26, 1993; No. 5,356,718 issued to Athey et al. on Oct. 18, 1994; No. 5,599,369 issued to Townsend et al. on Feb. 4, 1997; No. 5,698,262 issued to Soubeyrand et al. on Dec. 16, 1997; No. 6,238,738 issued to McCurdy on May 29, 2001; and No. 6,268,059 issued to Cronin et al. on Jul. 31, 2001. All of the patents cited herein are hereby expressly incorporated by reference as if fully set forth in their entirety herein.

Some examples of heat reflecting coatings, features of which may possibly be used or adapted for use in at least one embodiment of the present invention may be found in the following U.S. Pat. No. 4,188,452 issued to Groth on Feb. 12, 1980; No. 4,323,598 issued to Okino et al. on Apr. 6, 1982; No. 4,985,312 issued to Furuya et al. on Jan. 15, 1991; No. 5,085,926 issued to lida et al. on Feb. 4, 1992; No. 5,418,039 issued to Carter on May 23, 1995; and No. 5,894,047 issued to Tanaka on Apr. 13, 1999. All of the patents cited herein are hereby expressly incorporated by reference as if fully set forth in their entirety herein.

Some examples of borosilicate glass, features of which may possibly be used or adapted for use in at least one embodiment of the present invention may be found in the following U.S. Pat. No. 4,313,748 issued to Macedo et al. on Feb. 2, 1982; No. 4,386,164 issued to Moser on May 31, 1983; No. 4,438,210 issued to Rittler on Mar. 20, 1984; No. 5,612,262 issued to Kloss et al. on Mar. 18, 1997; and No. 6,204,212 issued to Kunert et al. on Mar. 20, 2001. All of the patents cited herein are hereby expressly incorporated by reference as if fully set forth in their entirety herein.

Some examples of providing a pattern or coloring, features of which may possibly be used or adapted for use in at least one embodiment of the present invention may be found in the following U.S. Pat. No. 6,114,054 issued to Klein et al. on Sep. 5, 2000; No. 6,183,939 issued to Demars et al. on Feb. 6, 2001; No. 6,187,429 issued to Weinberg et al. on Feb. 13, 2001; No. 6,214,414 issued to Tang et al. on Apr. 10, 2001; No. 6,228,194 issued to Cowen on May 8, 2001; No. 6,248,492 issued to Tavernier et al. on Jun. 19, 2001; and No. 6,287,996 issued to Chiba et al. All of the patents cited herein are hereby expressly incorporated by reference as if fully set forth in their entirety herein.

Some examples of stove or gas burner controls, features of which may possibly be used or adapted for use in at least one embodiment of the present invention may be found in the following U.S. Pat. No. 4,448,186 issued to Smith on May 15, 1984; No. 4,681,084 issued to Grech on Jul. 21, 1987; No. 4,834,188 issued to Silverman on May 30, 1989; No. 5,094,259 issued to Hsu on Mar. 10, 1992; No. 6,253,761 issued to Shuler et al. on Jul. 3, 2001; and No. 6,280,180 issued to Fredin-Garcia-Jurado on Aug. 28, 2001. All of the patents cited herein are hereby expressly incorporated by reference as if fully set forth in their entirety herein.

The following is in reference to coating of the glass material or glass substrate material or plate with tin oxide. It is well known to provide tin oxide coated glass. Tin oxide coatings may be rendered conductive so that the coating reduces the emissivity of the coated glass in respect of long wavelength infra-red radiation, in particular radiation having wavelengths greater than 3 micrometers.

It is known to render tin oxide coatings conductive by incorporating doping agents, and they may also include minor proportions of other compatible materials for various purposes. The nature and amount of any atoms present other than tin and oxygen should not exceed a limit above which the crystal lattice structure type of the coating differs from that of cassiterite, so as to preserve the transparency and durability of the coating. A simple, and perhaps simplistic, explanation of doping is that atoms are provided which are compatible with the tin oxide crystal lattice, and which have a different valency shell from both tin and oxygen. As a result, the doping atoms provide spare electrons, or electron gaps which can act as charge carriers through the coating.

Such coated glass is often used for glazing purposes to provide a measure of heat conservation, and also to provide a heat screen, for example a solar screen. Most solar radiation energy is at relatively short wavelengths, so that it can be transmitted by the coated glass provided that the coating and the glass are clear, but radiant energy from the interior of the glazed structure tends to be at longer wavelengths, so it is inhibited from escaping from the structure through the coated glazing. Such coatings are often made to a thickness in the range 200 nm to 800 nm.

One such product comprises float glass on which a tin oxide coating some 750 nm to 800 nm in thickness has been formed pyrolytically. This coating has excellent low emissivity, less than 0.2. Such low emissivity is in fact as good as can be achieved by applying a coating by a sputtering technique. The coating also has good color in reflection, in that it is a barely perceptible green. But because of its thickness, and also due to formation of the coating by pyrolysis, this coating has a level of haze which, while it is commercially acceptable for many purposes, is not as good as it could be. Some contrast in the haze over the extent of the coating area may also be apparent on inspection. When this coating is polished so as substantially to eliminate surface haze, any residual haze may be attributed to defects below the surface of the coating. This residual haze is referred to herein as internal haze. This known coating has an average internal haze value of 2%.

Typically, coated glass articles are produced by continuously coating a glass substrate while it is being manufactured in a process known in the art as the “Float Glass Process”. This process involves casting glass onto a molten tin bath which is suitably enclosed, then transferring the glass, after it has sufficiently cooled, to take-away rolls which are aligned with the bath, and finally cooling the glass as it advanced across the rolls, initially through a lehr and thereafter while exposed to the ambient atmosphere. A non-oxidizing atmosphere is maintained in the float portion of the process, while the glass is in contact with the molten tin bath, to prevent oxidation. An air atmosphere is maintained in the lehr. The chemical vapor deposition (CVD) of various coatings may be conveniently performed in the bath or the lehr, or even in the transition zone therebetween, by contacting the surface of the hot glass with chemical vapor containing reactants which pyrolytically decompose to form the metal oxide coating. This, of course, requires that the chemical reactants have vaporization temperatures below their thermal decomposition temperatures. Several tin compounds exist which may be vaporized to prepare a tin oxide coating on glass by CVD technology.

Both organic and inorganic tin compounds have been used for the deposition by chemical vapor deposition of fluorine doped tin oxide coatings. Thus, for example U.S. Pat. No. 4,329,379 issued to Terneu et al. on May 11, 1982, discloses a process for forming a fluorine doped tin oxide coating on a hot glass substrate by contacting the glass with the vaporized reactants of a tin tetrachloride, hydrofluoric acid (HF), air and water. Similarly, U.S. Pat. No. 4,387,134 issued to Kalbskopf et al. on Jun. 7, 1983, teaches that fluorine doped tin oxide films having sheet resistances of 1-10 ohm/square may be produced from a combination of vaporized water, methanol, HF, stannic chloride and H₂/N₂ gases.

A number of techniques are known for forming coatings on a vitreous substrate, including pyrolysis. Pyrolysis generally has the advantage of producing a hard coating, which precludes the need for a protective layer. The coatings formed by pyrolysis have durable abrasive- and corrosion-resistant properties. It is believed that this is due in particular to the fact the process involves depositing of coating material onto a substrate which is hot. Pyrolysis is also generally cheaper than alternative coating processes such as sputtering, particularly in terms of the investment in plant. The deposit of coatings by other processes, for example by sputtering, possibly leads to products with very different properties, in particular a lower resistance to abrasion and occasionally a different refractive index.

A wide variety of coating materials have been proposed for glazing panels, and for several different desired properties of the glazing. Tin oxide, SnO₂, has been widely used, often in combination with other materials such as other metal oxides. GB Patent 1455148 teaches a method for pyrolytically forming a coating of one or more oxides on a substrate, primarily by spraying compounds of a metal or silicon, so as to modify the light transmission and/or light reflection of the substrate, or to impart antistatic or electrically conductive properties. Its examples of specified oxides include ZrO₂, SnO₂, Sb₂O₃, TiO₂, CO₃O₄, Cr₂O₃, SiO₂ and mixtures thereof. Tin oxide (SnO₂) is seen as advantageous because of its hardness and its ability to have antistatic or electrically conductive properties. GB Patent 2078213 relates to a sequential spray method for pyrolytically forming a coating on a vitreous support and is particularly concerned with tin oxide or indium oxide as the main coating constituents. When its metal coating precursor is tin chloride this is advantageously doped with a precursor selected from ammonium bifluoride and antimony chloride in order to increase the electrical conductivity of the coating.

It is also known that where a coating of tin oxide is formed by pyrolysis of SnCl₄, the presence of a dopant such as antimony chloride SbCl₅, directly mixed with the tin chloride SnCl₄, improves the absorption and reflection of some near solar infrared radiation.

GB 2200139 describes and claims a method of forming a pyrolytic tin oxide coating on a hot glass substrate by spraying a solution containing a tin compound and additives which produce in the coating both fluorine and such materials as antimony, arsenic, vanadium, cobalt, zinc, cadmium, tungsten, tellurium and manganese so as to give the coating a low emissivity and a low specific internal haze factor.

The following U.S. patents relating to hard coatings of tin oxide or tin dioxide are hereby incorporated by reference as if set forth in their entirety herein: U.S. Pat. No. 4,900,634, issued to Terneu, et al. on Feb. 13, 1990; No. 5,698,262, issued to Soubeyrand, et al. on Dec. 16, 1997; No. and 6,231,971, issued to Terneu, et al. on May 15, 2001. All of the patents cited herein are hereby expressly incorporated by reference as if fully set forth in their entirety herein.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents but also equivalent structures.

Some further examples of appliances, in which features of the present invention may possibly be incorporated, may be found in the following U.S. Pat. No. 3,759,242 issued to Mauger on Sep. 18, 1973; No. 3,949,526 issued to Sherlock et al. on Apr. 13, 1976; No. 4,206,338 issued to Katona on Jun. 3, 1980; No. 4,753,043 issued to Bockwinkel on Jun. 28, 1988; No. 4,753,084 issued to Aoki on Jun. 28, 1988; No. 4,898,147 issued to Doni et al. on Feb. 6, 1990; No. 4,951,652 issued to Ferrario et al. on Aug. 28, 1990; No. 5,111,618 issued to Kaspar et al. on May 12, 1992; No. 5,405,263 issued to Gerdes et al. on Apr. 11, 1995; No. 5,428,968 issued to Tetsukawa et al. on Jul. 4, 1995; No. 5,689,967 issued to Fløysvik on Nov. 25, 1997; No. 5,694,831 issued to Haroum et al. on Dec. 9, 1997; No. 5,910,332 issued to Fakieh on Jun. 8, 1999; and No. 6,091,057 issued to Asami et al. on Jul. 18, 2000; No. 6,111,224 issued to Witt on Aug. 29, 2000; No. 6,153,866 issued to Andersson et al. on Nov. 28, 2000; No. 6,218,651 issued to Chung on Apr. 17, 2001; No. 6,293,276 issued to Owens et al. on Sep. 25, 2001; and No. 6,349,713 issued to Toyama on Feb. 26, 2002. All of the patents cited herein are hereby expressly incorporated by reference as if fully set forth in their entirety herein.

One feature of the invention resides broadly in an electric stove to cook food, comprising: an electric stove body; said electric stove body being configured with exterior surfaces comprising a base, and at least one wall, said exterior surfaces defining the interior of said electric stove; an electric arrangement configured and disposed to provide a predetermined temperature in said electric stove; control apparatus to control said electric arrangement to a predetermined temperature; a planar glass structure disposed on said electric stove body; said planar glass structure comprising at least one glass member; said at least one glass member comprising glass material, a first coating and a second coating; said first coating being disposed at a surface of said glass material; said second coating being disposed at a surface of said glass material; said glass material having a hardness; said first coating having a hardness; said first coating hardness being greater than the glass material hardness; said second coating having a hardness; said first coating hardness being greater than said second coating hardness; said first coating being configured to be sufficiently hard to minimize scratches on and abrasive wear to said first coating and to protect said glass material, at the surface on which said first coating is disposed, from scratches and abrasive wear during use of said electric stove; and said second coating being configured to minimize heat transmission through said second coating and to minimize heat transmission to or from said interior of said electric stove.

Another feature of the invention resides broadly in an appliance dealing with food, such as, a stove to cook food, an oven to cook food, a toaster oven to toast food, a microwave oven to heat food, a bar-be-cue to barbecue food, a rotisserie configured to rotate food during roasting of food, a cooler to cool food, a refrigerator to refrigerate food, a freezer to freeze food, a display freezer showcase to display frozen food, a bottle cooler to cool beverage containers, a baking oven to bake food, a grill for cooking food, a broiler to broil food, a roasting oven to roast food, said appliance comprising: a body; said body being configured with exterior surfaces comprising a base, and at least one wall, said exterior surfaces defining the interior of said appliance; an arrangement configured and disposed to provide a desired temperature in said appliance; a glass structure disposed on said body; said glass structure comprising at least one glass member; said at least one glass member comprising glass material, a first coating and a second coating; said first coating being disposed at a surface of said glass material; said second coating being disposed at a surface of said glass material; said glass material having a hardness; said first coating having a hardness; said first coating hardness being greater than the glass material hardness; said second coating having a hardness; said first coating hardness being greater than said second coating hardness; said first coating being configured to be sufficiently hard to minimize scratches on and abrasive wear to said first coating and to protect said glass material, at the surface on which said first coating is disposed, from scratches and abrasive wear during use of said appliance; and said second coating being configured to minimize heat transmission through said second coating and to minimize heat transmission to or from said interior of said appliance.

This invention as described hereinabove in the context of the preferred embodiments is not to be taken as limited to all of the provided details thereof, since modifications and variations thereof may be made without departing from the spirit and scope of the invention.

What is claimed is:

1. An electric stove to cook food, said electric stove comprising:
an electric stove body;
said electric stove body being configured with exterior surfaces comprising a base, side walls, a front wall, a top wall, a bottom wall, and a rear wall, said exterior surfaces defining the interior of said electric stove;
an electric heating arrangement configured and disposed to provide heat to cook food comprising electric heating elements to cook food arranged with the electric stove body of the electric stove to cook food with the electric stove;
control apparatus to control said electric heating elements of said electric heating arrangement to cook food with said electric heating elements;
a planar glass structure disposed at said electric stove body for use at least upon said electric heating elements, to cook food, being in use to cook food;
said planar glass structure comprising a first, outer, surface being disposed at the exterior of said electric stove body, and a second, inner, surface not accessible to a user and being disposed between said first, outer, surface and said electric heating elements in said interior of said electric stove body, said planar glass structure being disposed between said electric heating elements and the area of said electric stove;
a first, outer, layer disposed substantially fully over said first, outer, surface of said planar glass structure and being disposed between said electric heating elements and the area of said electric stove;
a second, inner, layer disposed substantially fully over said second, inner, surface of said planar glass structure and being disposed between said electric heating elements and the area of said electric stove;
said planar glass structure having a hardness which remains hard upon said electric heating elements to cook food being in use to cook food;
said first, outer, layer having a hardness;
said first layer hardness being greater than the planar glass structure hardness which remains hard upon said electric heating elements to cook food being in use to cook food;
said second, inner, layer having a hardness which remains hard upon said electric heating elements to cook food being in use to cook food;
said first layer hardness being greater than said second layer hardness;
said first, outer, layer being configured to be sufficiently hard to minimize scratches on and abrasive wear to said first, outer, layer and to protect said planar glass structure, at the surface on which said first layer is disposed, from scratches and abrasive wear during use of said electric stove both when said electric heating elements to cook food are in use to cook food and when electric heating elements to cook food are not in use to cook food; and
said second, inner, layer being configured to minimize throughput of heat through said second, inner, layer and to minimize heat from said interior of said electric stove reaching the exterior of said electric stove during use of said electric stove when said electric heating elements to cook food are in use to cook food.

2. The electric stove according to claim 1, wherein:
said second, inner, layer is configured to minimize the degree of opacity of said planar glass structure.

3. The electric stove according to claim 2, wherein:
said first, outer, layer and said second, inner, layer together are configured to maximize light transmissivity of said planar glass structure.

4. The electric stove according to claim 3, wherein:
said first, outer, layer and said second, inner, layer together are configured to maximize the color fidelity of said planar glass structure.

5. The electric stove according to claim 4, wherein:
said first, outer, layer and said second, inner, layer together are configured to minimize iridescence of said planar glass structure.

6. The electric stove according to claim 5, wherein;
said second, inner, layer configured to minimize throughput of heat through said second, inner, layer is configured to maximize thermal reflection of said planar glass structure.

7. The electric stove according to claim 6, comprising at least one of (A.), (B.), (C.), and (D.):
(A.) said second, inner, coating comprises one of: a soft metal comprising coating and a metal oxide coating; and
(B.) said second, inner, layer comprises at least one of: silver, aluminum, and gold, to form one of: a soft metal comprising coating and a metal oxide coating;
(C.) said second, inner, layer comprises one of: a coating sputtered onto said planar glass structure and a vapor deposited coating; and
(D.) said first, outer, layer comprises a doped tin dioxide coating.

8. An electric stove to cook food, comprising:
an electric stove body;
said electric stove body being configured with exterior surfaces comprising a base, and at least one wall, said exterior surfaces defining the interior of said electric stove;
an electric arrangement configured and disposed to provide a predetermined temperature in said electric stove;
control apparatus to control said electric arrangement to a predetermined temperature;
a planar glass structure disposed on said electric stove body;
said planar glass structure comprising at least one glass member;
said at least one glass member comprising glass material, a first coating and a second coating;
said first coating being disposed at a surface of said glass material;
said second coating being disposed at a surface of said glass material;
said glass material having a hardness;
said first coating having a hardness;
said first coating hardness being greater than the glass material hardness;
said second coating having a hardness;
said first coating hardness being greater than said second coating hardness;
said first coating being configured to be sufficiently hard to minimize scratches on and abrasive wear to said first coating and to protect said glass material, at the surface on which said first coating is disposed, from scratches and abrasive wear during use of said electric stove; and
said second coating being configured to minimize heat transmission through said second coating and to minimize heat transmission to or from said interior of said electric stove.

9. The electric stove to cook food according to claim 8 comprising all of (A.), (B.), (C.), (D.), (E.), (F.), (G.), (H.), (I.), and (J.):
(A.) said first coating is disposed on a surface of said glass material facing a user; and
said second coating is disposed on a surface of said glass material that is not accessible to a user during use;
(B.) said second coating configured to minimize heat transmission through said second coating is configured to maximize thermal reflection of said at planar glass structure;
(C.) said first coating and said second coating together are configured to maximize light transmissivity of said planar glass structure;
(D.) said first coating and said second coating together are configured to maximize the color fidelity of said planar glass structure;
(E.) said second coating is configured to minimize the degree of opacity of said planar glass structure;
(F.) said first coating and said second coating together are configured to minimize iridescence of said planar glass structure;
(G.) said second coating comprises one of: a soft metal comprising coating and a metal oxide coating;
(H.) said second coating comprises at least one of: silver, aluminum, and gold, to form one of: said soft metal comprising coating and said metal oxide coating;
(I.) said second coating comprises one of: a coating sputtered onto said glass material and a vapor deposited coating; and
(J.) said first coating comprises a doped tin dioxide coating.

10. The electric stove to cook food according to claim 8 comprising at least one of: (A.), (B.), (C.), (D.), (E.), (F.), (G.), (H.), (I.), and (J.):
(A.) said first coating is disposed on a surface of said glass material facing a user; and
said second coating is disposed on a surface of said glass material that is not accessible to a user during use;
(B.) said second coating configured to minimize heat transmission through said second coating is configured to maximize thermal reflection of said at planar glass structure;
(C.) said first coating and said second coating together are configured to maximize light transmissivity of said planar glass structure;
(D.) said first coating and said second coating together are configured to maximize the color fidelity of said planar glass structure;
(E.) said second coating is configured to minimize the degree of opacity of said planar glass structure;
(F.) said first coating and said second coating together are configured to minimize iridescence of said planar glass structure;
(G.) said second coating comprises one of: a soft metal comprising coating and a metal oxide coating;
(H.) said second coating comprises at least one of: silver, aluminum, and gold, to form one of: a soft metal comprising coating and a metal oxide coating;
(I.) said second coating comprises one of: a coating sputtered onto said glass material and a vapor deposited coating; and
(J.) said first coating comprises a doped tin dioxide coating.

11. An appliance dealing with food, such as, a stove to cook food, an oven to cook food, a toaster oven to toast food, a microwave oven to heat food, a bar-be-cue to barbecue food, a rotisserie configured to rotate food during roasting of food, a cooler to cool food, a refrigerator to refrigerate food, a freezer to freeze food, a display freezer showcase to display frozen food, a bottle cooler to cool beverage containers, a baking oven to bake food, a grill for cooking food, a broiler to broil food, a roasting oven to roast food, said appliance comprising:
a body;
said body being configured with exterior surfaces comprising a base, and at least one wall, said exterior surfaces defining the interior of said appliance;
an arrangement configured and disposed to provide a desired temperature in said appliance;
a glass structure disposed on said body;
said glass structure comprising at least one glass member;
said at least one glass member comprising glass material, a first coating and a second coating;
said first coating being disposed at a surface of said glass material;
said second coating being disposed at a surface of said glass material;
said glass material having a hardness;
said first coating having a hardness;
said first coating hardness being greater than the glass material hardness;
said second coating having a hardness;
said first coating hardness being greater than said second coating hardness;
said first coating being configured to be sufficiently hard to minimize scratches on and abrasive wear to said first coating and to protect said glass material, at the surface on which said first coating is disposed, from scratches and abrasive wear during use of said appliance; and
said second coating being configured to minimize heat transmission through said second coating and to minimize heat transmission to or from said interior of said appliance.

12. The appliance according to claim 11, wherein:
said first coating is disposed on a surface of said glass material facing a user; and
said second coating is disposed on a surface of said glass material that is not accessible to a user during use.

13. The appliance according to claim 12, wherein:
said second coating configured to minimize heat transmission through said second coating is configured to maximize thermal reflection from said glass structure.

14. The appliance according to claim 13, wherein:
said first coating and said second coating together are configured to maximize light transmissivity of said glass structure.

15. The appliance according to claim 14, wherein:
said first coating and said second coating together are configured to maximize the color fidelity of said glass structure.

16. The appliance according to claim 15, wherein:
said second coating is configured to minimize the degree of opacity of said glass structure.

17. The appliance according to claim 16, wherein:
said first coating and said second coating together are configured to minimize iridescence of said glass structure.

18. The appliance according to claim 17, comprising at least one of (A.) and (B.):
(A.) said second coating comprises one of: a soft metal comprising coating and a metal oxide coating; and
(B.) said second coating comprises at least one of: silver, aluminum, and gold, to form one of: a soft metal comprising coating and a metal oxide coating.

19. The appliance according to claim 18, wherein:
said second coating comprises one of: a coating sputtered onto said glass material and a vapor deposited coating.

20. The appliance according to claim 19, wherein:
said first coating comprises a doped tin dioxide coating.
